(19) United States
(12) Patent Application Publication
(10) Pub. No.: US 2010/0178957 A1
(43) Pub. Date: Jul. 15, 2010

(54) MOBILE DEVICE HAVING AN IMPACT RESISTANT INPUT

(76) Inventor: Chao Chen, Waterloo (CA)

Correspondence Address: QUARLES & BRADY LLP, 411 E. WISCONSIN AVENUE, SUITE 2040, MILWAUKEE, WI, 53202-4497, US

(21) Appl. No.: 12/353,200

(22) Filed: Jan. 13, 2009

(51) Int. Cl. H04B 1/38; G06F 1/16

(52) U.S. Cl. 455/565; 361/679.56

(57) ABSTRACT

A mobile device is disclosed having an impact resistant input located in at least one of the corners. In the event that the mobile device is dropped and lands on the corner input, a shock-absorbing member absorbs the energy of impact to prevent failure to a contact or input cap of the corner input.

### BACKGROUND OF THE INVENTION

The present disclosure relates generally to mobile devices. More specifically, the present invention is directed at an impact resistant input for a mobile device.

A primary benefit of a mobile device such as, for example, a BlackBerry™ is its portability. As the mobile device is not physically tethered to a specific location, the user can operate the mobile device almost anywhere. However, the portable nature of the mobile device also means that the mobile device may be constantly handled and, thus, is exposed to a wide array of potentially harmful conditions.

Some of these conditions may result in the undesired operation of the device. For example, when a mobile device is placed in a pocket, a bag, or the like, some of the user inputs may be inadvertently operated. To avoid this, many mobile devices have specific user inputs configured to temporarily disable the operation of the other user inputs on the device. To lock or unlock the user inputs on the mobile device, the mobile device may require that one or more user inputs must be pressed in isolation from any other user inputs. In this way, a user can selectively lock the operation of the mobile device when she is not using the mobile device to avoid unintentionally making a phone call, sending a text message, or operating the mobile device in some other way.

Further, the portable nature of the mobile device places the device at high risk to be physically damaged. For example, during handling, the mobile device may be dropped. From a sufficient height, the impact force can result in damage to the mobile device and, in particular, to any portions of the mobile device near the point of first impact. Typically, the first part of the mobile device to contact an impact surface will be a corner of the mobile device. Given the likelihood of damage to the corners of a mobile device in the event of a drop, most features and user inputs are placed on a flat surface that will be relatively well-protected.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an isometric view of a mobile device having a pair of user inputs located near the corners of one end of the mobile device;

FIG. 2 is an isometric view of the mobile device of FIG. 1, but in which portions of the device have been removed to reveal a pair of dome switches on the corners of one end of the mobile device;

FIG. 3 is an isometric view of the mobile device similar to FIG. 2 in which a shock-absorbing member has been placed over each of the pair of dome switches;

FIG. 3A is a detailed view of one of the corner inputs of the mobile device of FIG. 3 taken along line 3A-3A;

FIG. 3B is a detailed view of the other of the corner inputs of the mobile device of FIG. 3 taken along line 3B-3B;

FIG. 4 is a cross-sectional view taken along line 4-4 of FIG. 1 showing the components of one of the pair of user inputs;

FIG. 5 is a cross-sectional view similar to FIG. 4, but in which a sudden force is applied to the button cap and the shock-absorbing member is deformed;

FIG. 6 is a detailed view of the left shock-absorbing member;

FIG. 7 is another detailed view of the other side of the shock-absorbing member of FIG. 6;

FIG. 8 is a detailed view of the right shock-absorbing member; and

FIG. 9 is another detailed view of the other side of the shock-absorbing member of FIG. 8.

### DETAILED DESCRIPTION

A mobile device is disclosed with improved impact resistance upon an impact resulting from a drop. The mobile device includes a housing having at least one corner and an input located proximate one of the corners of the housing. The input includes a contact operably connected to the mobile device; an input cap accessible from an exterior of the mobile device, the input cap being positioned over the contact and being movable to manipulate the contact; and a shock-absorbing member positioned between the contact and the input cap.

In one form, the contact may be a dome switch.

In another form, the shock-absorbing member may be a silicone rubber having a Shore A hardness in the range of 50 to 60. However, the shock-absorbing member may also be a rubber material having a hardness in a range of 40 to 75 on the Shore A hardness scale.

In yet another form, the shock-absorbing member may include a securable portion securing the shock-absorbing member between the contact and the input cap. The shock-absorbing member may further include an absorbing portion positioned between the contact and the input cap.

In some forms, the shock-absorbing member may further include a thin portion between the securable portion and the absorbing portion in which the thin portion has a thickness less than the thickness of the absorbing portion. The thin portion may be elastically deflectable such that, when the input is operated, the securable portion and the absorbing portion are resiliently movable relative to one another.

In other forms, the securable portion of the shock-absorbing member may be secured to the housing to retain the shock-absorbing member between the contact and the input cap. The securable portion of the shock-absorbing member may include a through hole formed therein, a pin linked to the housing that is extended through the through hole of the securable portion, where the pin is heat staked to secure the shock-absorbing member between the contact and the input cap. The securable portion may further include a protrusion and the mobile device may further include a recess formed therein proximate the contact. The protrusion on the securable portion may be received in the recess formed proximate the contact to secure the shock-absorbing member between the contact and the input cap. The securable portion may also include a post extending therefrom that is received in a recess formed in the mobile device.

In yet another form, the mobile device may include a set of lockable inputs and the input located proximate the at least one corner of the housing is a lock key configured to enable and disable an operability of the set of lockable inputs.

In still yet another form, the input may be a mute key configured to mute a phone call on the mobile device. The mute key may also be configured to play and pause a playback of a media file on the mobile device.

In one form, the mobile device may include two inputs that are each formed proximate to a corner of the housing. The mobile device may be configured such that when both of the two inputs are simultaneously pressed, a function on the mobile device is performed.

In another form, the housing may have at least two corners with a midpoint located therebetween. In this form, the input is placed closer to one of corners than to the midpoint.

In still another form, the housing may include two essentially planar surfaces that are essentially parallel to one another with a set of peripheral side walls extending therebetween. The corner is formed along the set of peripheral side walls.

In another form, the input cap may be a membrane.

A mobile device is also disclosed with improved impact resistance upon an impact resulting from a drop. Again, the mobile device includes a housing having at least one corner and an input located proximate the corner of the housing. The input includes a dome switch operably connected to the mobile device; a membrane accessible from an exterior of the mobile device, the membrane positioned over the dome switch and movable to collapse the dome switch; and a shock-absorbing member positioned between the dome switch and the membrane. The shock-absorbing member includes a securable portion securing the shock-absorbing member between the dome switch and the membrane and an absorbing portion positioned between the dome switch and the membrane.

Thus, the disclosed mobile device provides an impact resistant input that can be located near a corner of the mobile device. In the event that the mobile device is dropped by the user, the shock-absorbing member absorbs the energy of a sudden impact if the input is the first portion of the mobile device to contact the impact surface. While such a sudden impact would likely damage the contact or the input cap of the input without the shock-absorbing member, the shock-absorbing member improves the durability and resiliency of the input such that the likelihood of impact failure is greatly decreased. Further, more design flexibility is provided in the arrangement of the user interface as the inputs may be located near corners of the mobile device with less concern about the failure of an input in the event the mobile phone is dropped.

To the accomplishment of the foregoing and related ends, the disclosure, then, comprises the features hereinafter fully described. The following description and the annexed drawings set forth in detail certain illustrative aspects of the disclosure. However, these aspects are indicative of but a few of the various ways in which the principles of the disclosure can be employed. Other aspects, advantages and novel features of the disclosure will become apparent from the following detailed description of the disclosure when considered in conjunction with the drawings.

The various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

The word “exemplary” is used herein to mean serving as an example, instance, or illustration. Any aspect or design described herein as “exemplary” is not necessarily to be construed as preferred or advantageous over other aspects or designs.

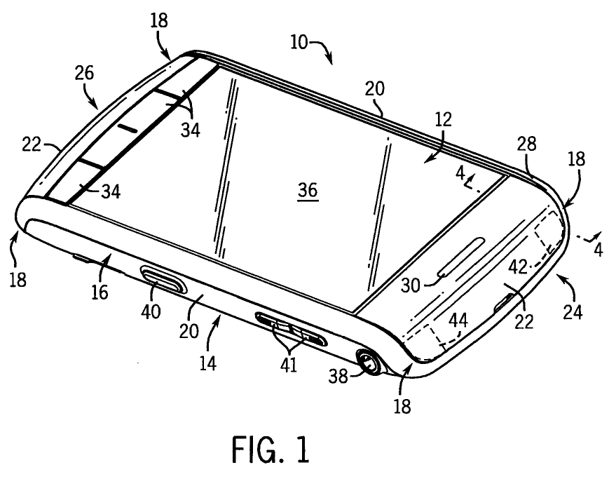

Referring first to FIG. 1, a mobile device 10 is shown. The mobile device 10 is a BlackBerry touchscreen mobile device, however the mobile device 10 could be any kind of mobile device 10 including, but not limited to, cellular phones, personal digital assistants, and the like. The mobile device 10 may be used as a phone, a digital media player, a camera, an e-mail client, an application platform, as well as any other functional uses for a mobile device that are known to those skilled in the art.

In the form shown, the mobile device 10 has a body with shape as described below. The mobile device 10 has a top surface 12 and a bottom surface 14 which are generally rectangular-shaped with rounded corners. The top surface 12 and the bottom surface 14 are essentially planar and essentially parallel to one another to provide the mobile device 10 with a thickness. A set of peripheral side walls 16 extend between the top surface 12 and the bottom surface 14. The set of peripheral side walls 16 includes two generally straight lateral walls 20 with curved walls 22 at a top end 24 and bottom end 26 of the mobile device 10. However, it is contemplated that in other forms, the peripheral side walls 16 could include flat surfaces, curved surfaces, surfaces that smoothly curve into the top surface 12 and/or the bottom surface 14, and the like.

Corners 18 are formed around the set of peripheral side walls 16. In the form shown, corner 18 occurs at each of the transitions between a straight lateral wall 20 and a curved wall 22. The corners 18 are smooth and continuous, but in other forms, the corners may have sharper or more defined edges.

Turning now to the specific elements of the mobile device 10, the mobile device 10 includes a housing 28 that supports the various sub-components of the mobile device 10. In the form shown, the housing 28 includes multiple joined structural elements, but in other forms the housing 28 may be a single monolithic body. On the top surface 12 of the mobile device 10, a speaker 30 is positioned near the top end 24 and a microphone (not shown) is positioned near the bottom end 26. The top surface 12 of the mobile device 10 also includes a set of buttons 34 and a display screen 36 for user operation of the mobile device 10. In the form shown, the display screen 36 is a touch screen, such that the user can provide input to the mobile device 10 by contacting the display screen 36, although it is recognized that other types of display screens may be appropriate. Along the lateral walls 20, various controls and connections are formed including a headphone jack 38 for connecting a set of headphones to the mobile device 10, a convenience key 40 for performing common tasks (e.g., opening an application, taking a picture using the built in-camera, and the like), volume keys 41 for adjustment of the speaker 30 volume, and a USB port (not shown) for connecting the mobile device 10 to a computer.

Notably, a set of corner inputs are formed proximate each of the corners 18 at the top end 24 of the mobile device 10. On the rightmost corner of the top end 24 of the housing 28 (it is noted that, in the isometric view of FIG. 1, the mobile device 10 is positioned such that the top end 24 is closest to the viewer at the bottom of FIG. 1), a lock key 42 is located. On the leftmost corner of the top end 24 of the housing 28, a mute key 44 is located. The pressure sensitive regions for operation of the lock key 42 and the mute key 44 are indicated in phantom lines as the pressure sensitive regions are integrally formed with surrounding parts of the body.

As used herein, the term “corner inputs” will be used to refer to and to describe both the lock key 42 and the mute key 44. In the form shown, each of the corner inputs is a depressible button or key with a momentary contact as will be described in further detail below. However, in other forms, these corner inputs could include various other types of user inputs or switches including, but not limited to, rockers, toggles, push-buttons, or the like in which some force must be applied to the input to mechanically actuate the corner input.

Given their location on the corners 18 of the mobile device 10, these corner inputs may be reserved for functions either for which the user will want quick access to or for which the location of the input on the corner 18 will serve to conveniently identify the input when the user does not want to look at the mobile device 10. For example, in the form shown, the lock key 42 is configured to enable and disable an operability of the set of inputs including the set of buttons 34 and the touch functionality of the display screen 36. The mute key 44 is configured to mute the microphone during a phone call on the mobile device 10 and is further configured to play or pause the playback of a media file if the mobile device 10 is being used as a digital media player. However, in other forms, the corner inputs could be assigned a different function or could be programmable to perform a particular function at the direction of the user.

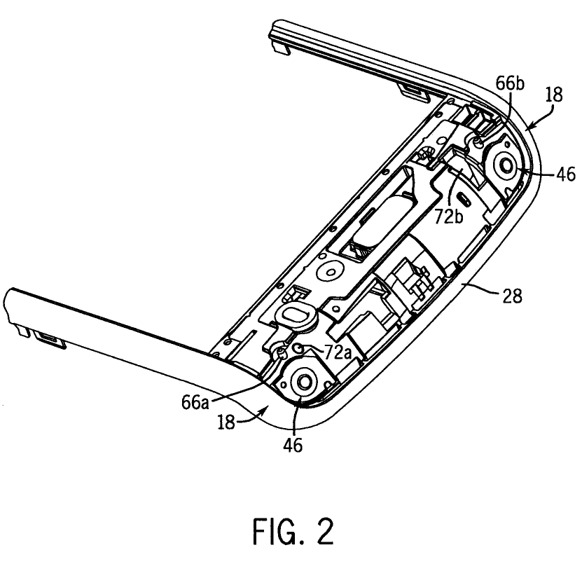

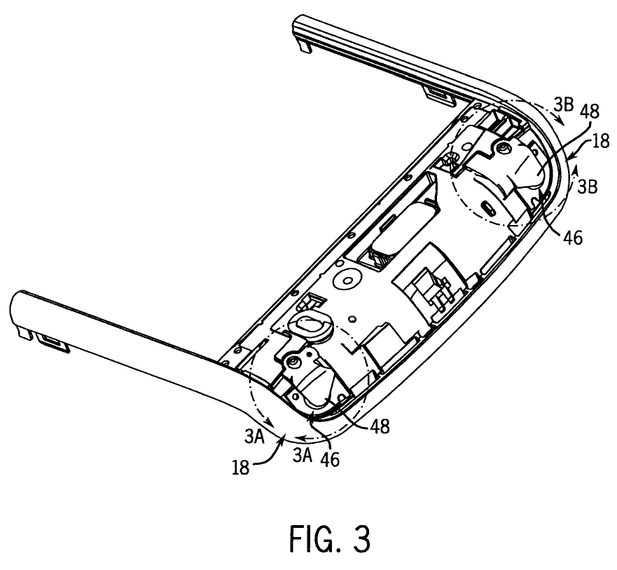

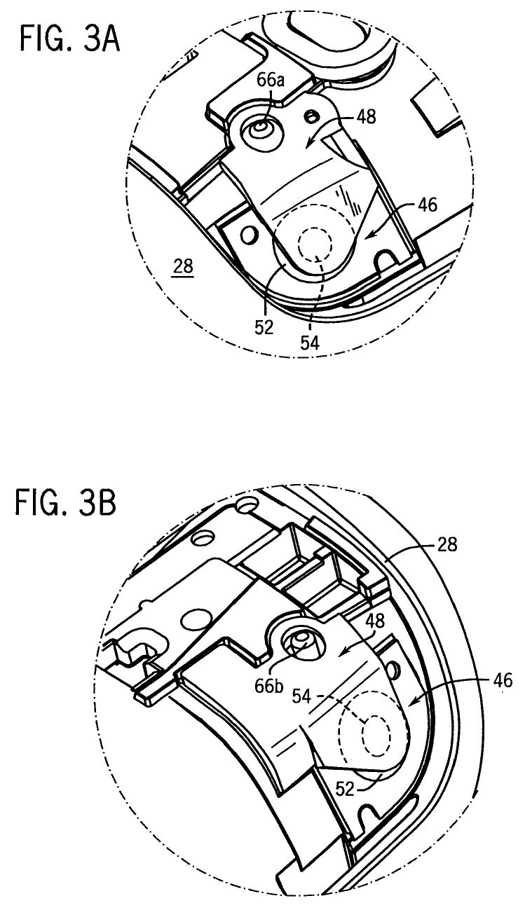

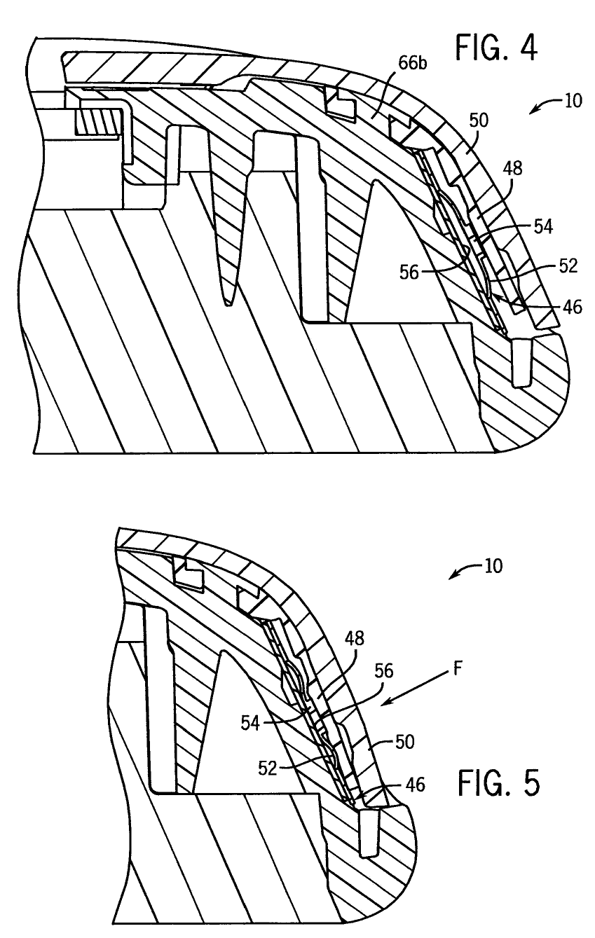

Referring now to FIGS. 2-5, the construction of the corner inputs is shown. Each corner input includes a dome switch 46 which serves as a contact, a shock-absorbing member 48, and an input cap 50. As best illustrated in FIG. 4, from the exterior of the mobile device 10 inward, the input cap 50 is positioned over a portion of the shock-absorbing member 48 which is placed over the dome switch 46. In general operation, when the user presses the input cap 50, the input cap 50 presses against the shock-absorbing member 48 which presses against the dome switch 46.

The dome switch 46 is a momentary contact switch which includes a collapsible dome 52 having a conductive interior, a plastic protrusion 54 normally made from glue and UV curing, and a surface 56 with conductive traces (not shown) drawn thereon. The conductive traces are connected to circuitry in the mobile device 10 which connects to a controller (not shown). The plastic protrusion 54 is placed at the peak of the collapsible dome 52 and is positioned over the conductive traces on the surface 56. The conductive traces drawn on the surface 56 do not intersect one another.

When the corner input is pressed or otherwise manipulated causing the displacement or movement of the input cap 50, the force is transferred from the input cap 50 through the shock-absorbing member 48 to the dome switch 46. When a force is applied to the dome switch 46, the collapsible dome 52 temporarily collapses such that the conductive interior of the collapsible dome 52 contacts the conductive traces drawn on the surface 56. The conductive interior of the collapsible dome 52 forms an electrical connection between the conductive traces. This connection is sensed by the controller which processes the corner input to perform an action or function associated with the corner input.

When the force applied to the corner input is removed, the collapsible dome 52 returns to its original dome shape, ending the momentary contact between the conductive traces. The return of the collapsible dome 52 to its original shape also biases the input cap 50 back to an un-depressed position.

In the form shown, the input cap 50 is an integrally formed continuous body, such as a membrane, having portions that may be depressed or deflected at the corner inputs. However, it is contemplated that the input cap 50 also could be a conventional hard plastic or metal key cap which is formed in a shape of a button that covers the corner input.

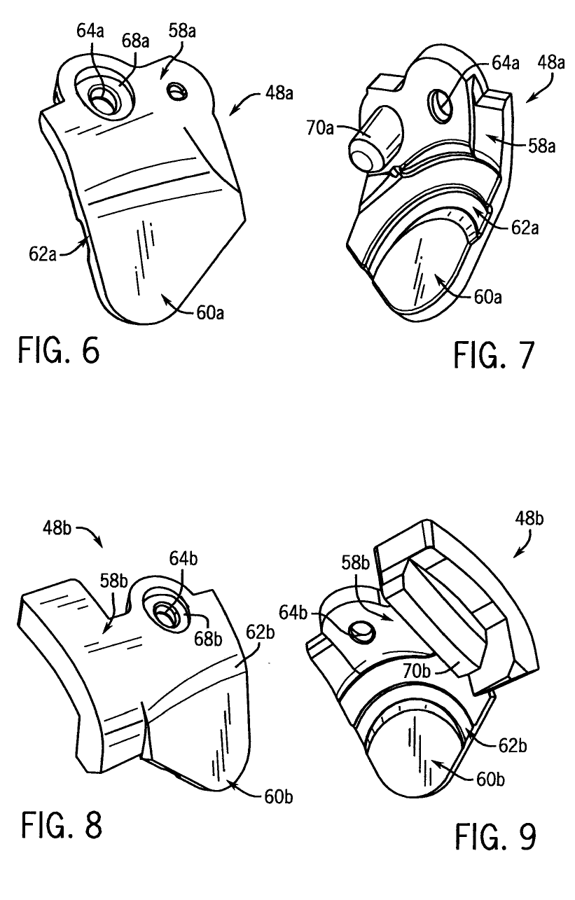

Now with reference to FIGS. 6-9, the details of the shock-absorbing members 48 are described. The shock absorbing members 48 include a left shock-absorbing member 48a and a right shock-absorbing member 48b. FIGS. 6 and 7 show the left shock-absorbing member 48a in which like numerals refer to like or corresponding elements in the right shock-absorbing member 48b in FIGS. 8 and 9. Where appropriate, any differentiating description between the left shock-absorbing member 48a and the right shock-absorbing member 48b is provided.

The shock-absorbing members 48 are made of a material with an elastic response time suitable for absorbing the impact energy of a drop. In an exemplary embodiment, the shock-absorbing members 48 are made of a silicone rubber having a hardness in the range of 50 to 60 on the Shore A hardness scale. In another embodiment, the shock-absorbing members 48 are made of a rubber material having a hardness in the range of 40 to 75 on the Shore A hardness scale.

Regardless of the particular material selected, the shock-absorbing members 48 are made of a flexible and resilient material with good impact resistance such that the shock-absorbing members 48 are able to elastically deform under a quickly applied impact force, such as the force F applied in FIG. 5. If the shock-absorbing members 48 are unable to absorb a large enough amount of the impact force, then it is possible that other parts of the corner input, such as the dome switch 46 or the input cap 50 may behave as rigid bodies under the sudden force. When the parts respond as rigid bodies, they are more likely to fail, resulting in a broken corner input.

Referring now to FIGS. 6 and 7, a left shock-absorbing member 48a includes a securable portion 58a and an absorbing portion 60a with a thin portion 62a extending therebetween.

The securable portion 58a may be secured, attached or otherwise fixed to the housing 28 or other portion of the mobile device 10 to position the shock-absorbing member 48a over the dome switch 46 or other contact. The securable portion 58a has a through hole 64a extending therethrough which can be slid over a pin 66a (best seen in FIG. 2) linked to the housing 28. This pin 66a is heat staked to thermally deform the tip of the pin 66a to secure the left shock-absorbing member 48a to the housing 28 to retain the left shock-absorbing member 48a between the dome switch 46 (or other contact) and the input cap 50. The through hole 64a may include a counterbore 68a located near the heat staked portion of the pin 66a to receive some of the melted tip of the pin 66a. The securable portion 58a also includes a protrusion 70a that fits into a recess 72a (FIG. 2) formed proximate the dome switch 46 or other contact. The protrusion 70a also secures the securable portion 58a of the left shock-absorbing member 48a between the contact and the input cap 50.

In the form shown, the combination of the heat staked connection and the protrusion connection prevents rotation of the shock-absorbing members 48. Comparing the protrusions 70a and 70b (i.e., the protrusion defined on the right shock-absorbing member 48b), it can be seen that the protrusion 70b resembles a key that would be inserted into a slot such as recess 72b (FIG. 2), while the protrusion 70a is a cylindrically-shaped post formed in the securable portion 58a and configured for engaging corresponding recess 72a. Thus, it is contemplated a protrusion (and corresponding recess) could take any one of a number of forms. However, in an exemplary embodiment also including a heat staked connection about a pin, these protrusions and recesses are geometrically formed so as to have surfaces that would interfere with one another on an attempt to rotate the shock-absorbing member about an axis of the pin.

The absorbing portion 60a is sandwiched between the dome switch 46 (or other contact) and the input cap 50 to transmit forces between the input cap 50 and the dome switch 46. Under a sudden impact force, such as may occur if the mobile device 10 is dropped and lands first on the corner 18 having a corner input, the absorbing portion 60a will absorb a large portion of the impact energy. As this energy is absorbed by the absorbing portion 60a, it does not need to be absorbed by the input cap 50 or the dome switch 46, which could fail under the sudden load.

The thin portion 62a has a thickness that is less than the thickness of the securable portion 58a and the absorbing portion 60a. As the thin portion 62a is composed of the same material as the rest of the shock absorbing members 48a, the reduction in cross-sectional thickness allows for easy deflection of the absorbing portion 60a relative to the securable portion 58a. When the input cap 50 is depressed, the thin portion 62a can easily deflect to allow the absorbing portion 60a to move with the input cap 50 and the dome switch 46 or other contact while the securable portion 58a remains secured. Likewise, when the input cap 50 is released, the dome switch 46 or other contact can apply a force that returns the absorbing portion 60a and the input cap 50 back to their original un-pressed position.

Thus, an impact resistant input for a mobile device is provided which is located proximate the corner of the mobile device. In the event that the mobile device is dropped, the possibility of input failure is reduced as the shock-absorbing member absorbs much of the energy of the impact. In previous mobile devices, the placement of an input near a corner of the mobile device would either need to be avoided or would create a high likelihood of damage to the input requiring repair of the mobile device. However, with the impact resistant input described herein, a mobile device can include a corner input, giving the designer more flexibility in the placement of the inputs of the user interface and reducing the likelihood of device failure in the event of a drop.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To apprise the public of the scope of this disclosure, the following claims are made:

What is claimed is:

1. A mobile device with improved impact resistance upon an impact resulting from a drop, the mobile device comprising:
a housing having at least one corner; and
an input located proximate the at least one corner of the housing, the input including:
a contact operably connected to the mobile device,
an input cap accessible from an exterior of the mobile device, the input cap positioned over the contact and movable to manipulate the contact, and
a shock-absorbing member positioned between the contact and the input cap.

2. The mobile device of claim 1, wherein the contact is a dome switch.

3. The mobile device of claim 1, wherein the shock-absorbing member comprises a silicone rubber having a Shore hardness in a range of 50 to 60 Shore A hardness.

4. The mobile device of claim 1, wherein the shock-absorbing member is a rubber material having a Shore hardness in a range of 40 to 75 Shore A hardness.

5. The mobile device of claim 1, wherein the shock-absorbing member includes a securable portion securing the shock-absorbing member between the contact and the input cap and an absorbing portion positioned between the contact and the input cap.

6. The mobile device of claim 5, wherein the shock-absorbing member further includes a thin portion between the securable portion and the absorbing portion, the thin portion having a thickness less than the thickness of the absorbing portion.

7. The mobile device of claim 6, wherein the thin portion is elastically deflectable such that, when the input is operated, the securable portion and the absorbing portion are resiliently movable relative to one another.

8. The mobile device of claim 5, wherein the securable portion of the shock-absorbing member is secured to the housing to retain the shock-absorbing member between the contact and the input cap.

9. The mobile device of claim 8, wherein the securable portion of the shock-absorbing member includes a through hole formed therein, where a pin linked to the housing extends through the through hole, the pin being heat staked to secure the shock-absorbing member between the contact and the input cap.

10. The mobile device of claim 8, wherein the securable portion of the shock-absorbing member further includes a protrusion and the mobile device further includes a recess formed therein proximate the contact and wherein the protrusion on the securable portion of the shock-absorbing member is received in the recess formed proximate the contact to secure the shock-absorbing member between the contact and the input cap.

11. The mobile device of claim 8, wherein the securable portion of the shock-absorbing member includes a post extending therefrom that is received in a recess formed in the mobile device.

12. The mobile device of claim 1, wherein the mobile device includes a set of lockable inputs and the input located proximate the at least one corner of the housing is a lock key configured to enable and disable an operability of the set of lockable inputs.

13. The mobile device of claim 1, wherein the input is a mute key configured to mute a phone call on the mobile device.

14. The mobile device of claim 13, wherein the mute key is also configured to play and pause a playback of a media file on the mobile device.

15. The mobile device of claim 1, wherein the mobile device includes two inputs, each of the two inputs formed proximate to a corner of the housing.

16. The mobile device of claim 15, wherein the mobile device is configured such that when both of the two inputs are simultaneously pressed a function on the mobile device is performed.

17. The mobile device of claim 1, wherein the housing has at least two corners with a midpoint located therebetween and wherein the input is placed closer to one of the at least two corners than to the midpoint.

18. The mobile device of claim 1, wherein the housing includes two essentially planar surfaces that are essentially parallel with one another and have a set of peripheral side walls extending therebetween and wherein the at least one corner is formed along the set of peripheral side walls.

19. The mobile device of claim 1, wherein the input cap is a membrane.

20. A mobile device with improved impact resistance upon an impact resulting from a drop, the mobile device comprising:
a housing having at least one corner; and
an input located proximate the at least one corner of the housing, the input including:
a dome switch operably connected to the mobile device,
a membrane accessible from an exterior of the mobile device, the membrane positioned over the dome switch and movable to collapse the dome switch, and
a shock-absorbing member positioned between the dome switch and the membrane, the shock-absorbing member including a securable portion securing the shock-absorbing member between the dome switch and the membrane and an absorbing portion positioned between the dome switch and the membrane.
